(19) United States
(12) Patent Application Publication
(10) Pub. No.: US 2012/0016053 A1
(43) Pub. Date: Jan. 19, 2012

(54) Cross Linked Biolaminate: Methods, Products and Applications

(76) Inventor: Michael J. Riebel, Mankato, MN (US)

(21) Appl. No.: 13/183,290

(22) Filed: Jul. 14, 2011

Related U.S. Application Data
(60) Provisional application No. 61/364,330, filed on Jul. 14, 2010.

(51) Int. Cl. C08J 3/28

(52) U.S. Cl. 522/183

(57) ABSTRACT

A method for crosslinking of the biolaminate to meet higher heat resistance and other functional performance needs for biolaminate surfacing products and applications is provided. Using such method, it is possible to change the overall performance characteristics of a biolaminate to address specific needs and applications. The crosslinked biolaminate can be either in a single layer or multilayer construction and either thermoformed or flat laminated onto a rigid composite substrate.

This application claims priority to U.S. Provisional Application No. 61/364,330, filed Jul. 14, 2010, the content of which is hereby incorporated in its entirety by reference.

### BACKGROUND

Laminates are typically high pressure laminates with over 6 billion square feet used in the US per year. HPL is produced by saturating multiple layers of paper with a thermosetting formaldehyde based resin in which the layers of sheets are thermally pressed together under significant heat and pressure.

Biolaminates are disclosed previously by the inventors integrating PLA, PHA, PHB and Cellulose Acetates for surfacing applications as an environmentally friendly and functional alternative to HPL.

### SUMMARY

A method for crosslinking of the biolaminate to meet higher heat resistance and other functional performance needs for biolaminate surfacing products and applications is provided. Using such method, it is possible to change the overall performance characteristics of a biolaminate to address specific needs and applications. The crosslinked biolaminate can be either in a single layer or multilayer construction and either thermoformed or flat laminated onto a rigid composite substrate.

A method for producing the continuous biolaminate sheet generally comprising the following steps: (1) preparing a sheet from a resin composition comprising a biodegradable resin, a crosslinking promoter; (2) irradiating the sheet with an ionizing radiation to crosslink the resin composition; and (3) subjecting the crosslinked sheet to heat treatment to continuously prepare a crosslinked biolaminate sheet.

Another method for producing a biolaminate comprises of combining a biopolymer, such as PLA and an acrylic additive, with a photoinitiator and compounding the biopolymer and the photoinitator to form a biolaminate film. Such compounding may be done as a separate step or within the film extrusion process. The resultant film is then exposed to either a UV or UV/Ebeam curing process to crosslink the biolaminate. An optional or additional crosslinking agent maybe used such as a peroxide or various metal oxide catalysts.

A method for production of a crosslinked biodegradable resin continuous biolaminate sheet for decorative and functional surfacing, comprising: a) preparing a sheet from a resin composition comprising a biobased resin (PLA, PHA, PHB, other biobased plastics) and a crosslinking promoter; b) irradiating the sheet with an ionizing radiation to crosslink the resin composition and promoting crosslinking of the biodegradable resin by the crosslinking promoter under ionizing irradiation; and c) subjecting the crosslinked sheet to heat treatment to continuously prepare a crosslinked biolaminate sheet comprising an irradiated crosslinked polymer comprising the biobased resin and the crosslinking promoter selected; from the group consisting of methacrylates and acrylates.

A product and method wherein Polylactic acid biolaminate as described wherein the crosslinked material comprises crosslinks that have been achieved by organic peroxide, ionizing radiation, or combinations thereof.

### DETAILED DESCRIPTION

The following invention teaches crosslinking of the biolaminate to meet higher heat resistance and other functional performance needs for biolaminate surfacing products and applications. Using such crosslinking, it is possible to change the overall performance characteristics of a biolaminate to address specific needs and applications. The crosslinked biolaminate can be either in a single layer or multilayer construction and either thermoformed or flat laminated onto a rigid composite substrate.

General Method

A method for producing the continuous biolaminate sheet generally comprising the following steps: (1) preparing a sheet from a resin composition comprising a biodegradable resin, a crosslinking promoter; (2) irradiating the sheet with an ionizing radiation to crosslink the resin composition; and (3) subjecting the crosslinked sheet to heat treatment to continuously prepare a crosslinked biolaminate sheet.

Another method for producing a biolaminate comprises of combining a biopolymer, such as PLA and an acrylic additive, with a photoinitiator and compounding the biopolymer and the photoinitator to form a biolaminate film. Such compounding may be done as a separate step or within the film extrusion process. The resultant film is then exposed to either a UV or UV/Ebeam curing process to crosslink the biolaminate. An optional or additional crosslinking agent maybe used such as a peroxide or various metal oxide catalysts.

A method for production of a crosslinked biodegradable resin continuous biolaminate sheet for decorative and functional surfacing, comprising: a) preparing a sheet from a resin composition comprising a biobased resin (PLA, PHA, PHB, other biobased plastics) and a crosslinking promoter; b) irradiating the sheet with an ionizing radiation to crosslink the resin composition and promoting crosslinking of the biodegradable resin by the crosslinking promoter under ionizing irradiation; and c) subjecting the crosslinked sheet to heat treatment to continuously prepare a crosslinked biolaminate sheet comprising an irradiated crosslinked polymer comprising the biobased resin and the crosslinking promoter selected; from the group consisting of methacrylates and acrylates.

A product and method wherein Polylactic acid biolaminate as described wherein the crosslinked material comprises crosslinks that have been achieved by organic peroxide, ionizing radiation, or combinations thereof.

In one embodiment to produce a sheet-like crosslinked biolaminate, crosslinking is carried out by a chemical crosslinking method in which a polymer such as PLA composition produced by compounding an organic peroxide, crosslinked agent in an extruder is processed into a crosslinked resin sheet or an electron radiation crosslinking method in which a sheet-like material produced by the addition of a crosslinked agent in an extruder. When polylactic acid is used, the organic peroxide used acts to increase the radical decomposition rate and this makes the electron radiation crosslinking method preferable because in this method, sheet production and crosslinking are performed in two separate steps, allowing the sheet production step to be carried out stably

Any suitable chemical initiator may be used including peroxide catalysts generating peroxidic radicals such as dicumyl peroxide, propionitrile peroxide, penzoil peroxide, di-t-butyl peroxide, diasyl peroxide, beralgonyl peroxide, mirystoil peroxide, tert-butyl perbenzoate, and 2,2′-azobisisobutyroriitrile; and catalysts for starting polymerization of monomers. Similarl to the irradiation of radioactive rays, it is preferable to perform crosslinking in an air-removed inert atmosphere or in a vacuum

Such crosslinking of polylactic acid biolaminate may be carried out before, during, or after the extrusion process to create the biolaminate layers. If it is crosslinked before or during the final biolaminating process, adequate care should be taken particularly about the crosslinkability of polylactic acid. Thus, if there is an excessively large different in crosslinkability among them, it will be difficult to produce form with uniform properties. So, it is preferable that the crosslinkability of each resin be examined in advance to allow individual layers of the biolaminate to be produced under conditions where the difference in crosslinkability has been minimized. To achieve such conditions with a minimized crosslinkability among the resins, the absolute value of the difference in fraction of PLA separately crosslinked under the same conditions should preferably be in the range of 0-50; more preferably 0-35. If the absolute value of the difference in PLA fraction is above, however, polyactic acid biolaminate sheet may be produced in some cases by using several polyfunctional monomers, performing radiation several times, or adjusting the crosslinking temperature appropriately.

When an organic peroxide is used to produce crosslinked biolaminate sheet, such an organic peroxide may be, for example, dicumyl peroxide, 2,5-dimethyl-2,5-di-(t-butylperoxy)-hexyne-3,.alpha.,.alpha-bis(t-butylperoxy diisopropyl)benzene, t-butylperoxy cumene, n-butyl-4,4′-di(t-butylperoxy)varelate, 1,1-di(t-butylperoxy)-3,3,5-trimethylcyclohexane, or 1,1-di(t-butylperoxy)cyclohexane. Said organic peroxidiis normally used in the range of 0.2-10 parts by weight relative to 100 parts by weight of the; resin composition. If the content of said organic peroxide is less than 0.2 parts by weight, the effect of its addition will not be achieved sufficiently, while if it is more than 10 parts by weight, crosslinking will take place to an excessive degree, and in addition, the resin may suffer radical decomposition, even leading to a decrease in viscosity. In embodiment of the invention, said polylactic acid biolaminate sheet comprises a crosslinked resin composition.

Ionizing radiation may be used to achieve such crosslinking. Such ionizing radiation may be, for example, alpha ray, beta ray, gamma ray or electron beam. The exposure dose of said ionizing radiation may vary depending on the desired degree of crosslinking, gloss and texture and thickness of the material under irradiation, etc., but in most cases, the required exposure dose is in the range of 1-200 kGy, more preferably 1-100 kGy. If the exposure dose is too small, crosslinking will not proceed sufficiently to achieved required effect, while if it is too large, the resin may be decomposed. Of the various types of ionizing radiation, electron beam is preferred because resin of different thicknesses can be crosslinked efficiently by changing the electron acceleration voltage appropriately. There are no limitations on the number of repetitions of the ionizing radiation process.

In the practice of this invention, it may be desirable to have one or more layers of the entire film cross-linked to improve the thermoformability, abuse and/or puncture and heat resistance and/or other physical characteristics of the entire film. Crosslinking is the predominant reaction which results in the formation of carbon-carbon bonds between polymer chains. Crosslinking may be accomplished, for example, by ionized radiation means such as high energy electrons, gamma-rays, beta particles and the like, or through chemical means by use of peroxides and the like. More particularly, for crosslinking with ionizing radiation, the energy source can be any electron beam generator operating in a range of about 150 kilovolts to about 6 megavolts with a power output capable of supplying the desired dosage. The voltage can be adjusted to appropriate levels which may be for example 1 to 6 million volts or higher or lower. Many apparatus for irradiating films are known to those skilled in the art. The films of the present invention may be irradiated at a level of from 2-12 Mrads, more preferably 2-5 Mrads. The most preferred amount of radiation is dependent upon the film and its end use.

Crosslinking Agents

The crosslinking agent for obtaining the crosslinked product of the rubber may also be used with varying degrees of crosslinking success and is not particularly limited, and any one of the crosslinking agents which have been conventionally used in each of PLA Biolaminate layers can be used.

Examples of the crosslinking agent include: sulfur; organic sulfur compounds; organic nitroso compounds such as aromatic nitroso compounds; oxime compounds; metal oxide such as zinc oxide and magnesium oxide; polyamines; selenium, tellurium and/or compounds thereof; various types of organic peroxides; resin crosslinking agents such as alkylphenol formaldehyde resins and brominated alkylphenol formaldehyde resins; organic organosiloxane based compounds having two or more SiH groups in the molecule; and the like. One or two or more types of the crosslinking agent can be used depending on the type and the like of the biopolymer. When the crosslinked product is obtained, in terms of the crosslinking efficiency of the rubber, rubber elasticity imparted to the resultant crosslinked product, the odor and the like, the crosslinking agent is used in a proportion of preferably 0.3 to 30 parts by weight, more preferably 0.5 to 15 parts by weight, and particularly preferably 0.5 to 5 parts by weight based on 100 parts by weight of the rubber. When the crosslinking agent is less than 0.3 parts by weight, insufficient crosslinking may be performed, whereby the rubber elasticity is likely to be deteriorated. In contrast, when the crosslinking agent is more than 30 parts by weight, it is likely that the resulting composition may have a stronger odor, or may be colorized.

Other examples of agents, but not limited to include various metal oxide catalysts silica, alumina, mag, iron, and other oxides.

Furthermore, when the crosslinked product is obtained, in addition to the aforementioned crosslinking agent, one, or two or more crosslinking activators can be used as needed. Examples of the crosslinking activator include guanidine based compounds such as diphenyl guanidine, aldehyde amine based compounds, aldehyde arxrmonium compounds, thiazole based compounds, sulfenamide based compounds, thiourea based compounds, thiram based compounds, dithiocarbamate based compounds; hydrosilylated catalysts of group transition metals such as palladium, rhodium and platinum, or compounds and complexes of the same, and the like.

Moreover, when the crosslinked product is obtained, in addition to the aforementioned crosslinking agent and crosslinking activator, compounds such as divinylbenzene, ethylene glycol dimethacrylate, trimethylolpropane triacrylate, zinc oxide, N,N-m-phenylene bismaleimide, metal halide, organic halide, maleic anhydride, glycidyl methacrylate, hydroxypropyl methacrylate and stearic acid may be also used as needed. Addition of such a compound enables the crosslinking efficiency by the crosslinking agent to be improved, and also enables the rubber elasticity to be imparted.

In the present invention, the biodegradable resin is preferably mixed with a crosslinking agent and/or a radical polymerization initiator. By mixing these agents, the degree of crosslinking of the biodegradable resin can be increased, the degree of branching of the biodegradable resin can be regulated, and the biodegradable resin becomes excellent in moldability in molding such as extrusion molding.

Examples of the crosslinking agent include a (meth)acrylic acid ester compound, polyvalent (meth)acrylate, diisocyanate, polyvalent isocyanate, calcium propionate, polyhydric carboxylic acid, polyvalent carboxylic acid anhydride, polyliiydric alcohol, a polyvalent epoxy compound, metal alkoxide and a silane coupling agents. In consideration of the stability, productivity and operational safety of the reaction, a (meth)acrylic acid ester compound is most preferable.

Preferable as the (meth)acrylic acid ester compound is a compound that has two or more (meth)acryl groups in the molecule thereof or a compound that has one or more (meth)acryl groups and one or more glycidyl or vinyl groups because such a compound is high in reactivity with the biodegradable resin, scarcely remains as monomers, is relatively low in toxicity, and is low in degree of coloration of the resin. Specific examples of such a compound include: glycidyl methacrylate, glycidyl acrylate, glycerol dimethacrylate, trimethylolpropane trimethacrylate, trimethylolpropane triacrylate, allyloxypolyethylene glycol monoacrylate, allyloxypolyethylene glycol monomethacrylate, polyethylene glycol dimethacrylate, polyethylene glycol diacrylate, polypropylene glycol dimethacrylate, polypropylene glycol diacrylate, polytetramethylene glycol dimethacrylate, diethylene glycol dimethacrylate and ethylene glycol dimethacrylate; the copolymers of the above-listed (meth)acrylic acid ester compounds different in the alkylene length in the alkylene glycol portion; and further, butanediol methacrylate and butanediol acrylate.

The mixing amount of the crosslinking agent is preferably 0.005 to 5 parts by mass, more preferably 0.01 to 3 parts by mass, and most preferably 0.1 to 1 part by mass in relation to 100 parts by mass of the PLA resin prior to extrusion into biolaminate sheet layers. When the mixing amount is less than 0.005 part by mass, the degree of crosslinking tends to be insufficient, and when the mixing amount exceeds 5 parts by mass, the crosslinking is performed to an excessively high degree, and hence the operability, tends to be disturbed.

As the radical polymerization initiator, organic peroxides satisfactory in dispersibility are preferable. Specific examples of such organic peroxides include: benzoyl peroxide, bis(butylperoxy)trimethylcyclohexane, bis(butylperoxy)cyclododecane, butylbis(butylperoxy)valerate, dicumyl peroxide, butylperoxybenzoate, dibutyl peroxide, bis(butylperoxy)diisopropylbenzene, dimethyldi(butylperoxy)hexane, dimethyldi(butylperoxy)hexyne and butylperoxycumene.

Additional Methods for Crosslink Biolaminates

The biopolymers used in the biolaminate can be blended with various photo initiators and the sheet can be subjected to UV light in which the photo initiators are or contain a cross linking agent for the biopolymer.

Cross-links can be formed by chemical reactions that are initiated by heat, pressure, or radiation. For example, mixing of an unpolymerized or partially polymerized resin with specific chemicals called crosslinking reagents results in a chemical reaction that forms cross-links. Cross-linking can also be induced in materials that are normally thermoplastic through exposure to a radiation source, such as electron beam exposure[citation needed], gamma-radiation, or UV light. For example, electron beam processing is used to cross-link the C type of cross-linked polyethylene. Other types of cross-linked polyethylene are made by addition of peroxide during extruding (type A) or by addition of a cross-linking agent (e.g. vinylsilane) and a catalyst during extruding and then performing a post-extrusion curing.

Cross-links are the characteristic property of thermosetting plastic materials. In most cases, cross-linking is irreversible, and the resulting thermosetting material will degrade or burn if heated, without melting. Especially in the case of commercially used plastics, once a substance is cross-linked, the product is very hard or impossible to recycle. In some cases, though, if the cross-link bonds are sufficiently different, chemically, from the bonds forming the polymers, the process can be reversed.

UV Crosslinking of Biolaminate

UV crosslinking can be accomplished on individual biolaminate sheet or film that will be secondarily laminated on a rigid substrate or other biolaminate layers.

Another embodiment can be wherein the biolaminate is first laminated onto a flat or 3D substrates wherein the biolaminate is thermoformed onto the substrate and is secondarily exposed to UV light to cross link the biolaminate in its final shape.

Ultraviolet light (UV) and electron beam (EB) curable materials are unique solvent-free compositions that cure (harden) in a fraction of a second upon exposure to a UV or EB source. The absence of solvent eliminates the need for large baking ovens used to process conventional solvent-based coatings (paints) and inks.

Industry's interest in UV/EB curable coating technology began in the 1960s. For example, the beverage industry's interest in UV/EB curable coatings was sparked by the government's announced program to begin allocating natural gas. Beverage companies were dependent on natural gas to process conventional solvent-based inks and coatings used to decorate beverage cans. The commercialization of UV curable inks in the 1970s enabled beverage companies to accommodate a reduced availability of natural gas with a technology that depended solely on readily available electric energy. As a bonus, companies such as Coors found that switching to UV curable inks for metal can decoration substantially reduced energy and operational costs.

Today's manufacturing environment, in which government is imposing strict reductions in emission of volatile organic compounds (VOC) and hazardous air pollutants (HAP), offers another strong incentive for industry to switch to UV/EB curable coating technology.

Benefits of Using UV/EB Curable Coatings

In addition to the already mentioned fast line speed (higher productivity) and solvent-free compositions, UV/EB curable coatings offer many more important benefits. These include:
Reduced floor space—UV/EB curing equipment is much more compact than conventional drying ovens, and the solvent-free compositions require less storage space than solvent-based coatings providing comparable dry film weight.
Suitable for heat-sensitive substrates—The fast line speeds achieved with UV/EB curable coatings and absence of thermal drying result in a relatively cool coating process which can be used for coating heat sensitive substrates, such as plastic, wood and paper.
Reduced in-process inventory A conventional thermal curing coating manufacturing process, requiring intermediate drying stages, can be converted into a single-step, in-line process with UV/EB curable coatings.
Lower insurance costs and reduced handling hazards—Solventless UV/EB curable coatings are rated as non-flammable liquids. This will result in reduced insurance costs, less stringent storage requirements and a reduction in handling hazards compared to flammable solvent-based coatings.
Compliant technology—Federal, state and local governments recognize the many advantages offered by UV/EB curable coatings in complying with VOC and HAP restrictions (see references 2, 3 and 4). For example, UV curable coatings for metal can application has been reported by the EPA to contain less than 0.01 VOC/gallon of coating (see reference 5). Coors reported no significant emission of ozone or other undesirable emissions from a UV can line for one billion cans per year (see reference 6).
Reduced costs—Several studies show a significant reduction in energy costs can be achieved by switching from conventional thermal curing coatings to UV/EB curable coatings. Additional studies show that switching to UV/EB curable coatings is less expensive than converting an existing solvent-based coating operation into a VOC and HAP compliant operation (see references land 8).
Proven technology—UV/EB curable coatings are a proven technology, used worldwide, that has been in commercial use since the 1960s.

The Chemistry of UV Curable Coatings

Most commercially used UV curable coatings are based on acrylate chemistry that cures via free radical polymerization. These liquid compositions typically contain a mixture of a reactive oligomer (30-60%), one or more reactive monomers (20-40%), a UV light-absorbing component (3-5%), and one or more additives (<1%). UV/EB curable inks may contain up to 20% pigment. A high pigment content such as used in UV inks typically requires up to 10% of photoinitiator

One of the many advantages of acrylate-basted coatings is the extensive number of oligomers containing urethane groups that can be prepared to meet a wide range of cured film properties. Polyols used to prepare urethane acrylates for UV/EB compositions include polyethers, polyesters, polybutadienes, etc.

Generally, a mixture of monofunctional (one acrylate group) and polyfunctional (more than one acrylate group) acrylates is used in order to optimize cured film properties and liquid coating cure speed. Monofunctional monomers tend to reduce viscosity more effectively than polyfunctional acrylates. The monofunctional monomers also reduce cured film shrinkage and increase the elasticity of the cured film. However, a high concentration of monofunctional monomer severely reduces the coating cure speed. Highly functionalized monomers increase coating cure speed and increase cured film resistance to abrasion. However, these two desirable cured film features are achieved at the sacrifice of embrittling the cured film and reducing adhesion to the substrate. Optimized coating properties are achieved by systematically balancing the oligomer and monomer concentrations.

The UV light absorbing component, called a photoinitiator, initiates the polymerization process upon exposing the liquid coating to an intense source of UV light. Photoinitiators typically absorb light in two wavelength regions: 260 nm and 365 nm. The absorption at the higher energy can be up to several orders of magnitude greater than the absorption at the lower energy (longer wavelength). The photoinitiator decomposes at a rate significantly faster than the rate of polymerization. It is this rapid photodecomposition that results in UV curable coating polymerizing instantaneously upon UV exposure.

A variety of photoinitiators are available that differ in wavelength absorption and mechanism for initiating polymerization. Wavelengths of intense absorption tend to favor coating surface cure while wavelength of lower absorption tends to favor coating through cure. Some applications require a combination of two or more different photoinitiators to achieve optimized cured film properties and coating cure speed.

Additives are a common ingredient typically used to optimize coating properties, such as liquid coating shelf life, cured film durability, adhesion to substrate and general cured film appearance.

The second most widely used UV curable composition is the cationic-cured coatings. Cationically-cured coatings are based on epoxy-polyol compounds that polymerize in the presence of an acid. The photoinitiator used in cationically-cured compositions generates a Bronsted acid upon exposure to UV light. One of the drawbacks in the cationically-cured systems is the limited raw material available for use in these formulations. A comparison of the cationically-cured and free radical cured coating systems is shown in Table 1.

The Chemistry of EB Curable Coatings

Acrylate and epoxy-polyol compositions that cure with UV light can be cured by exposure to high-energy electrons commonly referred to as EB curing. The electrons used in the curing process range from 80 to as high as 300 Kv. The higher the voltage the deeper the electrons penetrate into the coated substrate. In the case of acrylates, no photoinitiator is required for EB curing. However, cationically-cured compositions require a small amount of acid producing photoinitiator.

Cure Requirements

In general, UV curable coatings require a dose or radiant energy density of between 0.5 to 3.0 Joules/cm2 to achieve full cure at reasonable line speeds. Additional cure may result in embrittlement and/or discoloration of the cured film.

When curing with EB, it is critical to operate at the voltage that is optimum for the density of the coating being cured. Too high a voltage will result-in most of the electrons passing through the coating without effecting a cure. Too low a voltage will result in too few electrons penetrating the coating layer. The unit of measurement used for dose in EB curing is called a Megarad (Mrad). A typical power rating for a EB curing unit is 1,000 Mrad meter/minute. This means the EB unit delivers 1 Mrad at a line speed of 1,000 meter/minute. Decreasing the line speed by one-half doubles the applied dose. A typical dose used for EB curing is between 0.5 and 3.0 Mrads. It is important to use the minimum dose required to provide satisfactory film properties in EB curing as a higher dose may result in substrate degradation.

As with any other coating system, it is important to utilize a test method for determining when the UV/EB coating is fully cured. Several techniques, which can be used individually or in combination, are as follows:
Measuring a functional property—for example film modulus, film hardness, film adhesion and film gloss
Using a chemical method—for example, spectroscopic measurement of residual unsaturation, solvent extractables, cured film volatiles, and cured film solvent sensitivity.

UV curing is a chemical process in which a liquid ink or coating solidifies upon exposure to UV energy. Most traditional inks or coatings require a thermal oven, which uses heat to drive off solvents or water, thus solidifying the coating. Instead of using a heat-activated catalyst, UV inks and coatings contain photoinitiators, which are sensitive to specific wavelengths of UV energy to start the solidification process. Most UV curing processes are very fast, curing the ink or coating in a matter of seconds. As a result, production speeds increase dramatically. Often manufacturing processes that are currently batch or off-line can convert to a continuous or indexing production process. UV inks and coatings contain very little or no volatile organic compounds, eliminating the need for incinerators or other remediation. In addition, UV coatings typically have superior chemical and scratch resistance.

Typically the application of UV inks and coatings to a part is similar and familiar. For example, UV inks are often screen-printed, pad printed, offset, flexographic or ink jet. Likewise, UV coatings can be sprayed, flow coated, dip coated, curtain coated or vacuum coated. Because UV coatings tend to be high solids, even 100 percent solids, formulators have to work hard to create suitable viscosities for the desired application method.

What is claimed is:

1. A method for producing a continuous biolaminate sheet, the method comprising:
preparing a sheet from a resin composition comprising a biodegradable resin and a crosslinking promoter;
irradiating the sheet with an ionizing radiation to crosslink the resin composition; and
subjecting the irradiated sheet to heat treatment to continuously prepare a crosslinked biolaminate sheet.

2. A method for producing a biolaminate film, the method comprising:
providing a biopolymer comprising PLA and an acrylic additive;
adding a photoinitiator to the biopolymer;
compounding the biopolymer and photoiniator;
forming a biolaminate film from the compounded biopolymer and photoinitiator;
curing the biolaminate film to crosslink the biolaminate film.

3. The method of claim 2, wherein curing comprises exposing the film to UV radiation.

4. The method of claim 2, further comprising adding a crosslinking agent to the biopolymer.

5. The method of claim 2, wherein compounding the biopolymer and photoinitiator is done while extruding the film.

6. A method for production of a crosslinked biodegradable resin continuous biolaminate sheet for decorative and functional surfacing, the method comprising:
preparing a sheet from a resin composition comprising a biobased resin and a crosslinking promoter;
irradiating the sheet with an ionizing radiation to crosslink the resin composition and promoting crosslinking of the biodegradable resin by the crosslinking promoter under ionizing irradiation; and
subjecting the crosslinked sheet to heat treatment to continuously prepare a crosslinked biolaminate sheet.

7. The method of claim 6, wherein the biobased resin is selected from the group consisting of PLA, PHA, PHB, and other biobased plastics.

8. The method of claim 6, wherein the crosslinking promotor is one of a methacrylate or an acrylate.
